(19) United States
(12) Patent Application Publication
(10) Pub. No.: US 2026/0355952 A1
(43) Pub. Date: Nov. 12, 2026

(54) ROBOT CONTROL APPARATUS AND ROBOT SYSTEM

(71) Applicant: FANUC CORPORATION, Minamitsuru-gun, Yamanashi (JP)

(72) Inventor: Rintaro NAKANO, Minamitsuru-gun, Yamanashi (JP)

(73) Assignee: FANUC CORPORATION, Minamitsuru-gun, Yamanashi (JP)

(21) Appl. No.: 19/142,033

(22) PCT Filed: Feb. 2, 2023
(86) PCT No.: PCT/JP2023/003328

§ 371 Date: Jun. 20, 2025

(51) Int. Cl. B25J 9/16; B25J 15/06; B65G 61/00

(52) U.S. Cl. CPC B25J 9/1651; B25J 9/1679; B25J 15/0616; B65G 61/00

(57) ABSTRACT

Provided is a robot control apparatus capable of conveying an object without prolonging cycle time more than necessary and without dropping the object even if a holding force fluctuates. The robot control apparatus is for controlling the motion of a robot that lifts an object placed at a first point and places the object at a second point, and comprises: at least one processor; and at least one storage device that can store a program executed by the at least one processor and information about a conveyance path for the object from the first point to the second point. The at least one processor sets the jerk of the robot to a limit value or lower and changes the limit value in accordance with the holding force of the robot for holding the object, on the basis of the program when the object is to be moved horizontally in an accelerating manner or a decelerating manner in the conveyance path.

### TECHNICAL FIELD

The present disclosure relates to a robot control apparatus and a robot system, particularly to a robot control apparatus that controls the operation of a robot holding and transporting an object and a robot system including the robot control apparatus and the robot.

### BACKGROUND ART

Patent Documents 1, 2, and 3 describe techniques of controlling the acceleration of a robot holding and transporting an object or modifying the shape of a robot hand to keep the object from falling.

Patent Document 1 describes a loading device that sets an operation mode of an industrial robot depending on the state of an article to be loaded. According to the loading device of Patent Document 1, a controller allows the industrial robot to handle the target article at a normal acceleration if a specification item of the article given by an instruction device is within a predetermined range. In this loading device, the industrial robot handles the target article at a lower acceleration than the normal acceleration if the specification item of the article exceeds a predetermined value. This operation of the loading device reduces failure such as fall of a large article handled by the robot due to lack of a gripping capacity of a grip and an increased error in loading position.

Patent Document 2 describes a simulation device that simulates a holding operation of a device for holding a workpiece in an easy and accurate manner. Specifically, the simulation device of Patent Document 2 simulates whether a holding unit of a robot can hold an article or not. The simulation device includes a determination unit that determines whether the holding unit can hold the article based on a travel speed or acceleration of the holding unit, an operation command value of the holding unit calculated based on a travel path of the holding unit, and a mass of the article.

Patent Document 3 describes a food holding device that securely holds food in a limited working space and allows efficient packing of food. Specifically, Patent Document 3 describes a device for holding food contained in a bag. The holding device includes multiple pairs of holding members that sandwich and hold in a given direction the top of each of food bags stacked in a predetermined direction at a predetermined position. Two pairs of the holding members adjacent in the predetermined direction are located at different positions in a direction orthogonal to the predetermined direction.

### CITATION LIST

### Patent Document

Patent Document 1: Japanese Unexamined Patent Application, Publication No. H6-286875
Patent Document 2: Japanese Unexamined Patent Application, Publication No. 2018-103339
Patent Document 3: Japanese Unexamined Patent Application, Publication No. 2019-922

### DISCLOSURE OF THE INVENTION

### Problems to be Solved by the Invention

When a robot hand holds and transports an object such as a load, a force to hold the object (will be hereinafter referred to as a holding force) may vary depending on the shape of the object, how the object is held, or the surrounding situation. When the holding force decreases, the object being transported may possibly fall due to a change in speed. Transporting the object at a reduced speed to prevent the object from falling when the holding force is reduced, increases cycle time. If the holding force increases, there is no need to reduce the transport speed. Thus, it is desirable to have a robot control apparatus and a robot system that allow transport of the object without the object falling and without increasing the cycle time more than necessary even if the holding force varies.

### Means for Solving the Problems

A first aspect of the present disclosure is directed to a robot control apparatus for controlling an operation of a robot that lifts an object located at a first point and places the object at a second point. The robot control apparatus includes: at least one processor; and at least one storage that stores information on a transport path of the object from the first point to the second point and a program executed by the at least one processor, wherein the at least one processor sets a jerk of the robot to a limit value or less in a case of moving the object in a horizontal direction with acceleration or deceleration on the transport path and changes the limit value of the jerk according to a holding force with which the robot holds the object, based on the program.

A second representative aspect of the present disclosure is directed to a robot system including the robot control apparatus of the first aspect and a robot controlled by the robot control apparatus.

### BRIEF DESCRIPTION OF THE DRAWINGS

FIG. 1 is a configuration diagram illustrating an example of a configuration of a robot system according to a first embodiment of the present invention.

FIG. 2 is a view illustrating how a suction hand transports a load between pallets;

FIG. 3 is a view illustrating a transport path of the load taken by the suction hand.

FIG. 4 is a functional block diagram of a motor controller having the function of controlling a jerk limit value based on a negative pressure value.

FIG. 5 is a functional block diagram of the motor controller having the function of controlling a speed compensation value and an acceleration limit value based on a negative pressure value.

FIG. 6 is a configuration diagram illustrating a suction hand provided with an acceleration sensor.

FIG. 7 is a flowchart of the control by a robot control apparatus.

FIG. 8 is a block diagram illustrating an example of the configuration of the robot control apparatus constituted by a computer.

### PREFERRED MODE FOR CARRYING OUT THE INVENTION

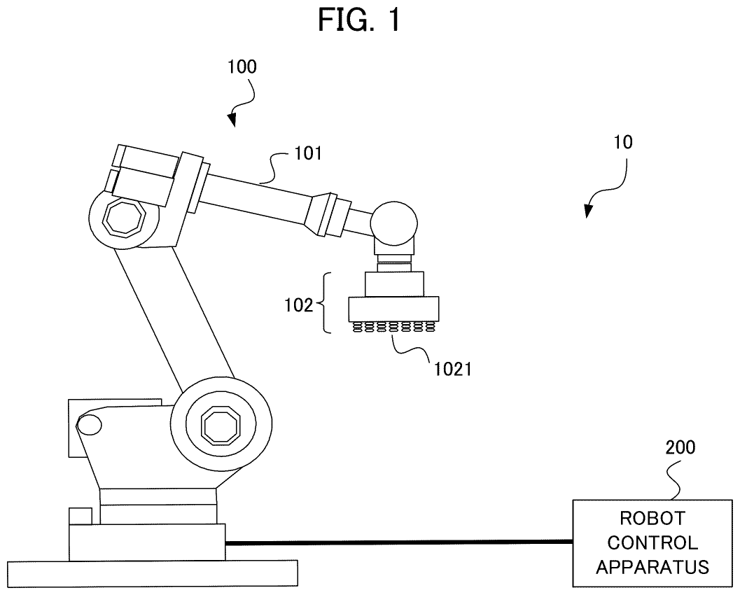

An embodiment of the present disclosure will be described below with reference to the drawings. FIG. 1 is a configuration diagram illustrating an example of a configuration of a robot system according to a first embodiment of the present invention.

As shown in FIG. 1, a robot system 10 includes a robot 100 that transports an object and a robot control apparatus 200 that controls the operation of the robot 100. The robot 100 and the robot control apparatus 200 are connected via a cable.

The robot 100 includes a robot mechanism 101 and a suction hand 102 attached to the end of the robot mechanism 101.

The robot mechanism 101 includes a plurality of articulated shafts each having a motor. The motors are controlled by an operation command from the robot control apparatus 200. Controlling the motors allows the robot mechanism 101 to move the suction hand 102 in vertical and horizontal directions.

The suction hand 102 includes a vacuum generator, a regulator that generates negative pressure, and a manometer that measures the negative pressure. The suction hand 102 includes a plurality of suction pads (may be referred to as vacuum pads) 1021 in each of which negative pressure is created by the vacuum generator and the regulator. When the negative pressure is created in the suction pads 1021, the suction pads 1021 suck the surface of a load to transport the load.

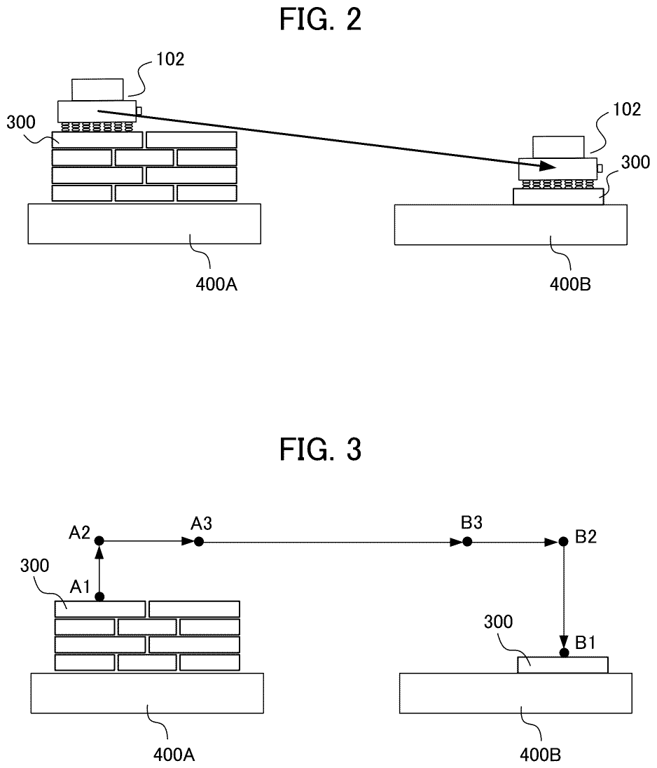

Referring to FIGS. 2 and 3, how the suction hand transports the load will be described below. FIG. 2 is a view illustrating how the suction hand transports the load between pallets. FIG. 3 is a view illustrating a transport path of the load taken by the suction hand. In FIG. 3, points A1, A2, A3, B3, B2, and B1 are points at which the suction pads 1021 at the center of the suction hand 102 make contact with a bag-shaped load 300. The points A1, A2, A3, B3, B2, and B1 change as the load to be transported changes, and the transport path of the load also changes. The robot control apparatus 200 controls the operation of the robot mechanism 101 to move the suction hand 102 and the suction and release of the suction hand 102. As shown in FIGS. 2 and 3, the suction hand 102 transports the bag-shaped load 300 placed on a pallet 400A to a pallet 400B on the transport path of the load 300 passing the points A1, A2, A3, B3, B2, and B1 in order. The suction hand 102 sucks the load at the point A1 and releases the load at the point B1. In the present embodiment, for example, the point A1 on the pallet 400A is the first point. In the present embodiment, for example, the point B1 on the pallet 400B is the second point.

The transport path from the point A1 to the point B1 includes a section where the suction hand 102 moves with a small speed variation, a section where the suction hand 102 moves with a large speed variation, and a section where the suction hand 102 moves with both of small and large speed variations. The suction hand 102 moves with a small speed variation in a section between the points A1 and A2 and a section between the points B2 and B1. The suction hand 102 moves with a large speed variation in a section between the points A2 and A3 and a section between the points B3 and B2. The suction hand 102 moves with both of small and large speed variations in a section between the points A3 and B3.

The reason why the speed variation increases in the section between the points A2 and B2 is that the distance between the points A2 and B2 is longer than the distance between the points A1 and A2 or the distance between the points B2 and B1, and a sudden increase or decrease in speed is required. The reason why the suction hand 102 moves with both of small and large speed variations in the section between the points A3 and B3 is that the speed variation needs to be increased in some cases taking the cycle time into account.

The section between the points A1 and A2 is an acceleration/deceleration section where the load in a stationary state is transported in the vertical direction, and then is decelerated in the vertical direction to a stop. The section between the points B2 and B1 is an acceleration/deceleration section where the load in a stationary state is transported in the vertical direction, and then is decelerated in the vertical direction to a stop. The section between the points A2 and A3 is an acceleration section where the load in a stationary state at the point A2 is transported in the horizontal direction and accelerated in the horizontal direction. The section between the points B3 and B2 is a deceleration section where the load is decelerated in the horizontal direction and stops at the point B2. The section between the points A3 and B3 is an acceleration/deceleration section where the load is accelerated and decelerated in the horizontal direction.

The suction hand 102 includes the regulator that controls the negative pressure. The negative pressure may vary depending on the shape of the load to be transported, how the suction hand 102 holds the load, and the surrounding situation. When the negative pressure varies, the force of the suction hand 102 to suck the load 300 (will be hereinafter referred to as a suction force) varies. The negative pressure value represents the suction force which is a holding force. When a load to be transported is bag-shaped, the surface of the load is more likely to bend and return to the original shape on the transport path as compared to a box-shaped load, causing the negative pressure value to easily vary.

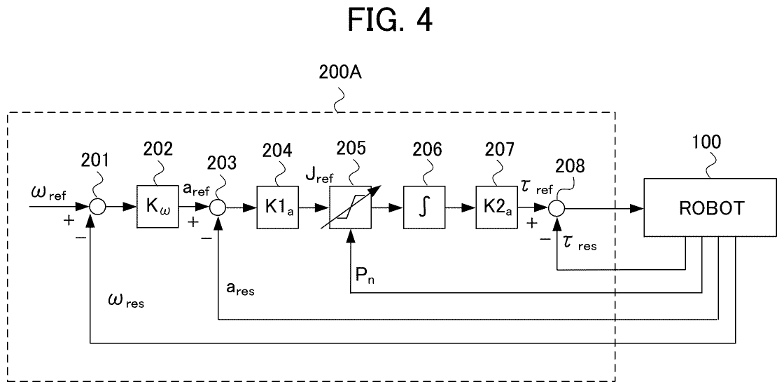

In the section between the points A2 and A3 and the section between the points B3 and B2 where the speed variation is large, the load may fall if the suction force of the suction hand 102 decreases as the negative pressure decreases and the variation in acceleration causes a large impact force. For example, when a speed command shown in FIG. 4 is inputted as a step command, an acceleration command is given as an impulse command. This exerts a sudden impact force during the transport, and the load may fall if the suction force decreases. If the negative pressure increases and the suction force of the suction hand 102 increases, the load is less likely to fall although the variation in acceleration causes a large impact force. Thus, in the section between the points A2 and A3 and the section between the points B3 and B2, a jerk command (jerk is also referred to as jolt) is set to a limit value or less, and the limit value is controlled based on the negative pressure value outputted from the manometer of the suction hand 102. If the negative pressure decreases and the suction force, or the holding force, of the suction hand 102 decreases, the limit value is reduced so that the load does not fall. If the negative pressure increases and the suction force, or the holding force, of the suction hand 102 increases, the limit value is increased to further reduce the cycle time. The limit value will be hereinafter referred to as a jerk limit value. An example of this control will be described later with reference to a functional block diagram shown in FIG. 4.

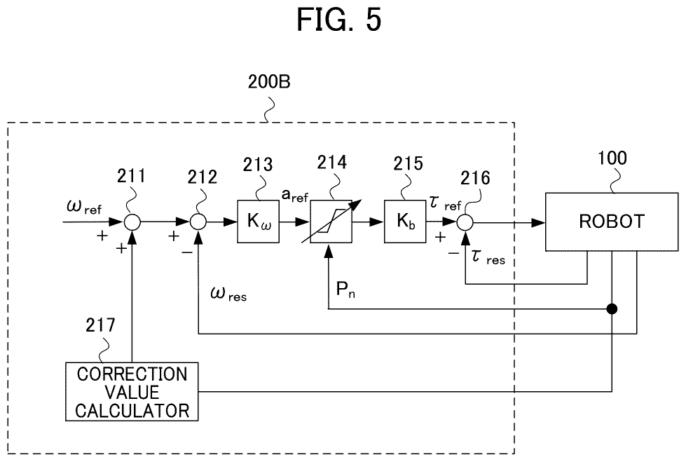

In the section between the points A1 and A2 and the section between the points B2 and B1 where the speed variation is small, the distance to travel is short, and the acceleration varies less. Thus, the load is less likely to fall due to the impact force although the negative pressure decreases and the suction force of the suction hand 102 decreases. However, the load may fall if a large force is exerted on the load by a large acceleration. If the negative pressure increases and the suction force of the suction hand 102 increases, the load is less likely to fall although the acceleration is large. Thus, an acceleration command is set to a limit value or less in the section between the points A1 and A2 and the section between the points B2 and B1, and the limit value is controlled based on the negative pressure value outputted from the manometer of the suction hand 102. If the negative pressure decreases and the suction force, or the holding force, of the suction hand 102 decreases, the limit value is reduced so that the load does not fall. If the negative pressure increases and the suction force, or the holding force, of the suction hand 102 increases, the limit value is increased to further reduce the cycle time. The limit value will be hereinafter referred to as an acceleration limit value. An example of this control will be described later with reference to a functional block diagram shown in FIG. 5.

The suction hand 102 may move with both of small and large speed variations in the section between the points A3 and B3. When the speed variation is large, the load may fall depending on the variation in negative pressure. Thus, if the variation in negative pressure exceeds a threshold value, the jerk command is set to the jerk limit value or less as is done by the control for the section between the points A2 and A3 and the section between the points B3 and B2, and the jerk limit value is controlled based on the negative pressure value. If the variation in negative pressure is equal to or less than the threshold value, the acceleration command is set to the acceleration limit value or less as is done by the control for the section between the points A1 and A2 and the section between the points B2 and B1, and the acceleration limit value is controlled based on the negative pressure value. The variation in negative pressure corresponds to the variation in holding force. Thus, in the section between the points A3 and B3, switching between the control of the jerk command to the jerk limit value or less and the control of the acceleration command to the acceleration limit value or less is performed based on the variation in negative pressure.

In addition to or as a replacement for the setting of the acceleration command to the acceleration limit value or less and the control of the acceleration limit value based on the negative pressure value outputted from the manometer of the suction hand 102 in the section between the points A3 and B3, the speed may be changed based on the negative pressure value outputted from the manometer of the suction hand 102. Although the negative pressure decreases and the suction force, or the holding force, of the suction hand 102 decreases, the load is less likely to fall as long as the speed variation is sufficiently small. The fall of the load can be avoided by merely changing the speed based on the negative pressure value outputted from the manometer of the suction hand 102. Then, a speed compensation value is added to reduce the speed variation of the speed command. If the negative pressure increases and the suction force of the suction hand 102 increases, the load is less likely to fall although the speed variation is large. Then, a speed compensation value is added to increase the speed variation of the speed command, and the cycle time is further reduced. Thus, the speed compensation value is controlled based on the negative pressure value outputted from the manometer of the suction hand 102. An example of this control will be described later with reference to a functional block diagram shown in FIG. 5. The same control can be performed for the section between the points A1 and A2 and the section between the points B2 and B1.

Referring to the functional block diagram shown in FIG. 4, the function of the robot control apparatus 200 to set the jerk command value to the jerk limit value or less and control the jerk limit value based on the negative pressure value will be described below. FIG. 4 is a functional block diagram of a motor controller having the function of controlling the jerk limit value based on the negative pressure value. A motor controller 200A shown in FIG. 4 is included in the robot control apparatus 200 and controls the motors of the robot mechanism 101. As shown in FIG. 4, the motor controller 200A includes a subtracter 201, an acceleration command generator 202, a subtracter 203, a jerk command generator 204, a jerk variable limiter 205, an integrator 206, a torque command generator 207, and a subtracter 208.

The subtracter 201 obtains a difference between an inputted speed command ω_{ref} and a speed response ωᵣₑₛ and outputs the difference as a speed deviation to the acceleration command generator 202.

The speed command is generated based on a program for operating the motors that drive the articulated shafts of the robot mechanism 101. The speed response is a detection speed detected by a rotary encoder associated with the motor.

The acceleration command generator 202 outputs a value obtained by multiplying the speed deviation by a speed gain Kω as an acceleration command a_{ref} to the subtracter 203.

The subtracter 203 obtains a difference between the acceleration command a_{ref} and an acceleration response aᵣₑₛ and outputs the difference as an acceleration deviation to the jerk command generator 204. The acceleration response is obtained by differentiating the speed response.

The jerk command generator 204 multiplies the acceleration deviation by an acceleration gain K1a and outputs the obtained value as a jerk command J_{ref} to the jerk variable limiter 205.

The jerk variable limiter 205 reduces the jerk of the jerk command J_{ref} to the jerk limit value or less and outputs the jerk command J′_{ref} with the jerk reduced to the jerk limit value or less to the integrator 206. The jerk variable limiter 205 controls the jerk limit value based on the negative pressure value outputted from the manometer of the suction hand 102.

The integrator 206 integrates the jerk command J′_{ref} to generate an acceleration command a′_{ref} with the jerk reduced to the jerk limit value or less and outputs the acceleration command a′_{ref} to the torque command generator 207.

The torque command generator 207 multiplies the jerk command a′_{ref} by an acceleration gain K2a and outputs the obtained value as a torque command τ_{ref} to the subtracter 208. The subtracter 208 obtains a difference between the torque command τ_{ref} and a torque response τᵣₑₛ and outputs the difference as an operation command to the motors of the articulated shafts of the robot mechanism 101. The torque response is obtained by measuring a current value of the motor and multiplying the measured current value by a torque multiplier.

Referring to the functional block diagram shown in FIG. 5, it will be described below the function of the robot control apparatus 200 to set the acceleration command value to the acceleration limit value or less, control the acceleration limit value based on the negative pressure value, and calculate the speed compensation value for compensating for the speed command based on the negative pressure value. FIG. 5 is a functional block diagram of the motor controller having the function of controlling the speed compensation value and the acceleration limit value based on the negative pressure value. A motor controller 200B shown in FIG. 5 is included in the robot control apparatus 200 and controls the motors of the robot mechanism 101. As shown in FIG. 5, the motor controller 200B includes an adder 211, a subtracter 212, an acceleration command generator 213, an acceleration variable limiter 214, a torque command generator 215, and a subtracter 216.

The adder 211 obtains the sum of an inputted speed command ω_{ref} and a speed compensation value ωₐₛₛ and outputs the sum as a compensated speed command to the subtracter 212.

The subtracter 212 obtains a difference between the compensated speed command ω_{ref} and a speed response ωᵣₑₛ and outputs the difference as a speed deviation to the acceleration command generator 213. The speed response is a detection speed detected by a rotary encoder associated with the motor.

The acceleration command generator 213 outputs a value obtained by multiplying the speed deviation by a speed gain Kω as an acceleration command a_{ref} to the acceleration variable limiter 214.

The acceleration variable limiter 214 reduces the acceleration of the acceleration command a_{ref} to the acceleration limit value or less and outputs an acceleration command a′_{ref} with the acceleration reduced to the acceleration limit value or less to the torque command generator 215. The acceleration variable limiter 214 controls the acceleration limit value based on the negative pressure value outputted from the manometer of the suction hand 102.

The torque command generator 215 multiplies the acceleration command a′_{ref} by an acceleration gain Kb and outputs the obtained value as a torque command τ_{ref} to the subtracter 216.

The subtracter 216 obtains a difference between the torque command τ_{ref} and a torque response τᵣₑₛ and outputs the difference as an operation command to the motors of the articulated shafts of the robot mechanism 101. The torque response is obtained by measuring a current value of the motor and multiplying the measured current value by a torque multiplier.

A compensation value calculator 217 calculates a speed compensation value ωₐₛₛ based on the negative pressure value outputted from the manometer of the suction hand 102.

The functional blocks of the motor controllers 200A and 200B described above are merely examples, and are not limited to those shown in FIGS. 4 and 5 except that the control of the jerk limit value by the jerk variable limiter 205, the control of the acceleration limit value by the acceleration variable limiter 214 and the control of the speed compensation value are performed based on the negative pressure value outputted from the manometer of the suction hand 102. For example, P control shown in FIGS. 4 and 5 may be replaced with other control such as PI control. In FIGS. 4 and 5, the difference between the torque command τ_{ref} and the torque response τᵣₑₛ is obtained as the operation command for the torque control. However, the torque control may be omitted by removing the subtracter 216 and using the torque command τ_{ref} as the operation command without using the torque response τᵣₑₛ.

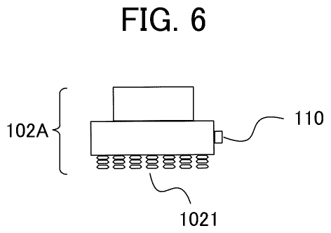

In FIGS. 4 and 5, the speed response ωᵣₑₛ and the acceleration response aᵣₑₛ are obtained using a speed detected by the rotary encoder. However, the acceleration response and the speed response can be obtained by detecting the acceleration by an acceleration sensor attached to the suction hand 102 and calculating the speed by integrating the detected acceleration. FIG. 6 is a view illustrating a suction hand provided with an acceleration sensor. The suction hand 102A includes an acceleration sensor 110. The robot control apparatus 200 obtains the speed by integrating the acceleration detected by the acceleration sensor 110 to obtain the acceleration response and the speed response.

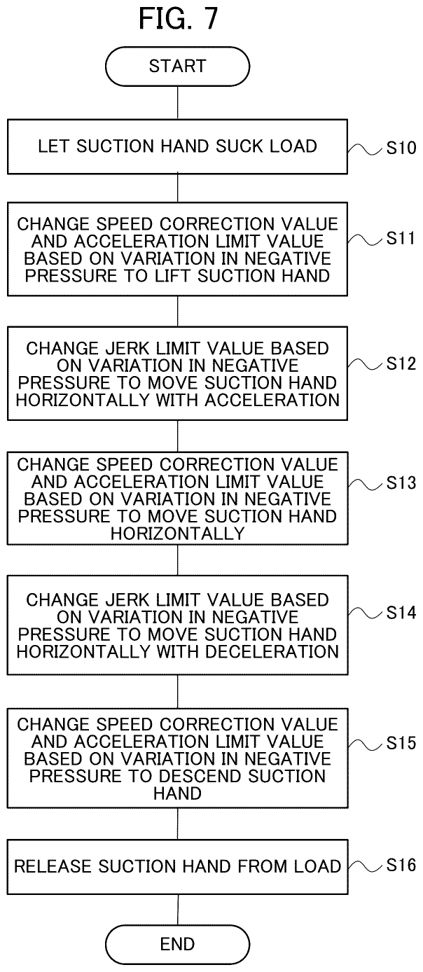

Control by the robot control apparatus will be described below. FIG. 7 is a flowchart of the control by the robot control apparatus. As shown in FIG. 3, the robot control apparatus 200 controls the suction hand 102 to transport the bag-shaped load 300 on the transport path passing the points A1, A2, A3, B3, B2, and B1 in order. The following description will be made on the assumption that the load is transported in the horizontal direction in the section between the points A3 and B3 while varying the compensation value of the speed command and the limit value of the acceleration based on the variation in negative pressure as shown in FIG. 5.

In Step S10, the robot control apparatus 200 allows the robot mechanism 101 to move the suction hand 102 to a position above the pallet 400A and generates negative pressure in the suction pads of the suction hand 102 above the pallet 400A to suck the load 300 onto the suction hand 102 as shown in FIG. 2.

In Step S11, as shown in FIG. 5, the robot control apparatus 200 changes the speed compensation value and the acceleration limit value based on the variation in negative pressure and controls the robot mechanism 101 to lift the suction hand 102 from the point A1 to the point A2 and stop the suction hand 102 at the point A2.

In Step S12, as shown in FIG. 4, the robot control apparatus 200 changes the jerk limit value based on the variation in negative pressure and controls the robot mechanism 101 to move the suction hand 102 in the horizontal direction with acceleration from the point A2 to the point A3.

In Step S13, as shown in FIG. 5, the robot control apparatus 200 changes the speed compensation value and the acceleration limit value based on the variation in negative pressure and controls the robot mechanism 101 to move the suction hand 102 in the horizontal direction from the point A3 to the point B3.

In Step S14, as shown in FIG. 4, the robot control apparatus 200 changes the jerk limit value based on the variation in negative pressure and controls the robot mechanism 101 to move the suction hand 102 in the horizontal direction with deceleration from the point B3 to the point B2 and stop the suction hand 102 at the point B2.

In Step S15, as shown in FIG. 5, the robot control apparatus 200 changes the speed compensation value and the acceleration limit value based on the variation in negative pressure and controls the robot mechanism 101 to descend the suction hand 102 from the point B2 to the point B1 and stop the suction hand 102 at the point B1 on the pallet 400B.

In Step S16, as shown in FIG. 2, the robot control apparatus 200 returns the pressure in the suction pads of the suction hand 102 on the pallet 400B to normal pressure to release the load 300 from the suction hand 102. The process from Step S10 to Step S16 transports the load 300 from the pallet 400A to the pallet 400B.

The components included in the robot control apparatus of the above-described embodiment can be implemented by hardware, software, or a combination of the hardware and the software. The expression “implemented by the software” means that a computer reads and executes a program to implement the components. The robot control apparatus includes a processor such as a central processing unit (CPU) to implement the components included in the robot control apparatus by the hardware, the software, or the combination of the hardware and the software. The processor also functions as an executor. The robot control apparatus may include two or more processors running in parallel. The robot control apparatus also includes an auxiliary storage such as a hard disk drive (HDD) that stores various programs such as application software or an operating system (OS) and a main storage such as random access memory (RAM) that stores a program required for the processor to execute the function shown in FIG. 4 or 5 and the operation shown in FIG. 7 and data temporarily required by the program. The robot control apparatus may include two or more storages. The data to be stored is, for example, information on the transport path from the point A1 to the point B1, that is, from the first point to the second point. The information includes coordinate information of the points A1, A2, A3, B3, B2, and B1. The points A1, A2, A3, B3, B2, and B1 change as the load to be transported changes, and the transport path of the load also changes.

In the robot control apparatus, the processor reads the application software or the OS from the auxiliary storage and performs calculation based on the application software or the OS while developing the read application software or OS in the main storage. Various types of hardware of the robot control apparatus are controlled based on the calculation result. Thus, the functional blocks of the present embodiment are implemented.

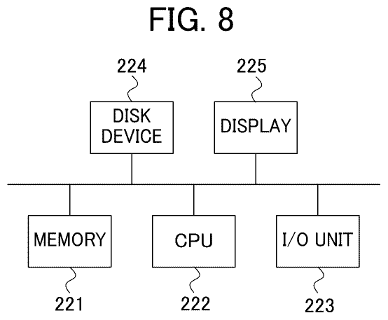

FIG. 8 is a block diagram illustrating an example of the configuration of the robot control apparatus constituted by a computer. As shown in FIG. 8, the computer as the robot control apparatus includes memory 221 which is a main storage, a CPU 222, an I/O unit 223 for connection with the robot 100 via a cable, a disk device 224 as an auxiliary storage such as an HDD, and a display 225. The display 225 displays the number of transports of the load and the value of negative pressure variation.

The components of the robot control apparatus can be implemented by hardware including an electronic circuit. When the robot control apparatus is constituted by the hardware, part or all of the functions of the components of the robot control apparatus can be implemented by an integrated circuit (IC), for example, an application specific integrated circuit (ASIC), a gate array, a field programmable gate array (FPGA), and a complex programmable logic device (CPLD).

The program is stored in various types of non-transitory computer readable media and supplied to the computer. The non-transitory computer readable media include various types of tangible storage media. Examples of the non-transitory computer readable media include a magnetic recording medium (e.g., a hard disk drive), a magneto-optical recording medium (e.g., a magneto-optical disk), a compact disc read only memory (CD-ROM), a CD-R, a CD-R/W, and semiconductor memory (e.g., mask ROM, programmable ROM (PROM), erasable PROM (EPROM), flash ROM, and random access memory (RAM) ). The program may be supplied to the computer by various types of transitory computer readable media.

The above-described embodiment has the following advantages.
(1) The object does not fall although the suction force decreases, and a robot hand with a greater suction force is no longer required. This reduces costs and causes no deformation of the object by an increased suction force.
(2) If the suction force increases, the speed compensation value, the acceleration limit value, and the jerk limit value can increase, reducing the cycle time.
(3) Although the suction force decreases, the object being transported swings less during the transport by reducing the acceleration limit value and the jerk limit value, keeping the object from falling.
(4) Although the suction force decreases, reducing the jerk limit value keeps the object from falling without exerting a reaction similar to an impact force on the robot.

### Variations

In the embodiment, a suction hand has been described as an example of a robot hand that transports the load. However, the robot hand is not limited to the suction hand, and a gripper using a pressure such as a negative or positive pressure or a gripper using a fluid can also be used as the robot hand. The robot hand may be a magnetic hand that sucks an object using a magnetic force.

### First Variation

A gripper having fingers that can bend when pressurized may decrease in gripping force which is the holding force if a negative pressure source is shared among plural systems and the pressurization is insufficient. A value of applied pressure and the gripping force are correlated. Thus, the value of applied pressure is sensed to calculate the gripping force, and the speed compensation value, the acceleration limit value, and the jerk limit value can be changed based on the calculated gripping force.

### Second Variation

The fluid gripper uses a fluid injected in a gripper part and magnetizes or electrifies the fluid to change its viscosity so that the gripper part changes its hardness to grip an object. The viscosity can be changed by bringing a neodymium magnet close to or away from a magnetic fluid using a servomotor. The neodymium magnet has high retentivity and is less likely to demagnetize spontaneously. However, the neodymium magnet demagnetizes when the servomotor is heated after moving the magnet multiple times. The demagnetization lowers the viscosity, and the gripping force which is the holding force may decrease. The magnetic force can be generated by using electrical properties, or the viscosity of the fluid can be changed by electrification. In either case, the robot hand requires electricity. A source for supplying electricity can be a servo amplifier of the robot or an external power source such as a DC stabilized power source. However, the gripping force may be insufficient if the electricity varies, for example, if it is turned on or off due to a ground wire shared with the robot requiring high power or the state of the fluid to be electrified. In either case, a magnetic flux density or a resistance of the fluid can be detected by a magnetic sensor or a current sensor, or a current variation due to interference from other environmental conditions can be observed. From these values, a variation in gripping force as the holding force can be calculated, and the values can be used as reference values for determining the speed compensation value, the acceleration limit value, and the jerk limit value. Thus, the technique described in the embodiment is also effective for the gripping hand using the fluid.

### Third Variation

A magnetic hand sucks and transports a metal part or any other objects using a magnetic force. Although the gripping hand may require a wide transport path depending on its size, the magnetic hand can suck and transport the object even on a narrow transport path with a magnetic force. The degree of holding of the object with the electromagnetic force also changes depending on the variation in heat or current value in the same manner as in the second variation. If the object to be transported is circular or corrugated and has a surface which is not flat, an electrical resistance value or a magnetic flux density also varies depending on a holding area, and the holding force can be calculated from the values detected by sensors such as a current sensor, a voltage sensor, and a magnetic sensor. These values can be used as reference values for determining the speed compensation value, the acceleration limit value, and the jerk limit value by the technique described in the embodiment. Thus, the technique described in the embodiment is also effective for the magnetic hand using the electromagnetic force.

The robot control apparatus and the robot system described in the embodiment and the variations are advantageous in that the object is transported without falling and without adding the cycle time more than necessary.

The present disclosure has just been described above, but the present disclosure is not limited to the embodiment and the variations. The embodiment and the variations can undergo various additions, replacements, modifications, and partial deletions as long as they do not deviate from the spirit of the present disclosure or from the scope of the claims and their equivalents described herein. The embodiment and the variations may be implemented in combination. For example, the order of the operations and the sequence of the processes in the above-described embodiment are presented as examples, and the present disclosure is not limited thereto.

The following additional remarks related to the embodiment and the variation will be disclosed below.

### Additional Remark 1

A robot control apparatus (200) for controlling an operation of a robot (100) that lifts an object located at a first point and places the object at a second point. The robot control apparatus includes: at least one processor (222); and at least one storage (221) that stores information on a transport path of the object from the first point to the second point and a program executed by the at least one processor, wherein the at least one processor (222) sets a jerk of the robot to a limit value or less in a case of moving the object in a horizontal direction with acceleration or deceleration on the transport path and changes the limit value of the jerk according to a holding force with which the robot holds the object, based on the program.

### Additional Remark 2

The robot control apparatus of the additional remark 1, wherein the at least one processor (222) changes a speed of the robot or a limit value of an acceleration of the robot according to the holding force in a case of moving the object in the horizontal direction on the transport path.

### Additional Remark 3

The robot control apparatus of the additional remark 1 or 2, wherein the at least one processor (222) changes a limit value of an acceleration of the robot according to the holding force in a case of moving the object in a vertical direction on the transport path.

### Additional Remark 4

The robot control apparatus of any one of the additional remarks 1 to 3, wherein the holding force varies over time.

### Additional Remark 5

The robot control apparatus of any one of the additional remarks 1 to 3, wherein the holding force varies over time, and the at least one processor (222) sets the jerk of the robot to the limit value of the jerk or less in a case where a variation of the holding force exceeds a threshold value in a case of moving the object in the horizontal direction on the transport path.

### Additional Remark 6

The robot control apparatus of any one of the additional remarks 1 to 5, wherein the object is a bag-shaped load (300).

### Additional Remark 7

A robot system (10) including the robot control apparatus (200) of any one of the additional remarks 1 to 6 and a robot (100) controlled by the robot control apparatus.

### Additional Remark 8

The robot system of the additional remark 7, wherein the robot has a robot hand that holds the object by suction.

### EXPLANATION OF REFERENCE NUMERALS

10 Robot system
100 Robot
101 Robot mechanism
102 Suction hand
110 Acceleration sensor
200 Robot control apparatus
201 Subtracter
202 Acceleration command generator
203 Subtracter
204 Jerk command generator
205 Jerk variable limiter
206 Integrator
207 Torque command generator
208 Subtracter
211 Adder
212 Subtracter
213 Acceleration command generator
214 Acceleration variable limiter
215 Torque command generator
216 Subtracter
217 Compensation value calculator

1. A robot control apparatus for controlling an operation of a robot that lifts an object located at a first point and places the object at a second point, the robot control apparatus comprising:
at least one processor; and
at least one storage capable of storing information on a transport path of the object from the first point to the second point and a program executed by the at least one processor,
wherein the at least one processor sets a jerk of the robot to a limit value or less in a case of moving the object in a horizontal direction with acceleration or deceleration on the transport path and changes the limit value of the jerk according to a holding force with which the robot holds the object, based on the program.

2. The robot control apparatus according to claim 1, wherein the at least one processor changes a speed of the robot or a limit value of an acceleration of the robot according to the holding force in a case of moving the object in the horizontal direction on the transport path.

3. The robot control apparatus according to claim 1, wherein the at least one processor changes a limit value of an acceleration of the robot according to the holding force in a case of moving the object in a vertical direction on the transport path.

4. The robot control apparatus according to claim 1, wherein the holding force varies over time.

5. The robot control apparatus according to claim 1, wherein the holding force varies over time, and the at least one processor sets the jerk of the robot to the limit value of the jerk or less in a case where a variation of the holding force exceeds a threshold value in a case of moving the object in the horizontal direction on the transport path.

6. The robot control apparatus according to claim 1, wherein the object is a bag-shaped load.

7. A robot system comprising the robot control apparatus of claim 1 and a robot controlled by the robot control apparatus.

8. he robot system of claim 7, wherein the robot has a robot hand that holds the object by suction.
